(19) United States
(12) Patent Application Publication
(10) Pub. No.: US 2021/0133270 A1
(43) Pub. Date: May 6, 2021

(54) REFERENCING MULTIPLE UNIFORM RESOURCE LOCATORS WITH COGNITIVE HYPERLINKS

(71) Applicant: International Business Machines Corporation, Armonk, NY (US)

(72) Inventors: Shailendra Moyal, Pune (IN); Akash U. Dhoot, Pune (IN); Nitin Sampatrao Jadhav, Pune (IN); Venkata Vara Prasad Karri, Visakhapatnam (IN)

(21) Appl. No.: 16/674,375

(22) Filed: Nov. 5, 2019

(51) Int. Cl. G06F 16/955; G06F 16/93; G06F 16/9035; G06F 17/22; G06F 16/9038

(52) U.S. Cl. CPC G06F 16/9566; G06F 16/94; G06F 16/9038; G06F 17/2235; G06F 16/9035

(57) ABSTRACT

Aspects of the present invention disclose a method, computer program product, and system for determining a presentation of URLs within a hyperlink. The method includes one or more processors determining information associated with a user accessing a document, wherein the document includes a hyperlink that is associated with a plurality of uniform resource locators (URLs). The method further includes one or more processors identifying, that the user selects the hyperlink within the document. The method further includes one or more processors determining a presentation of one of more URLs of the plurality of URLs of the hyperlink for the user based on the determined information associated with the user.

### BACKGROUND OF THE INVENTION

The present invention relates generally to the field of document management, and more particularly to adaptive hyperlinks within a document.

A Uniform Resource Locator (URL) (i.e., a web address) is a reference to a web resource that specifies its location on a computer network and a corresponding mechanism for retrieving the web resource. URLs occur most commonly to reference web pages (http) but are also used for file transfer (ftp), email (mailto), database access (JDBC), and many other applications. A web resource can be any “thing” or entity that can be identified, named, addressed or handled, in any manner, in the web at large, or in any networked information system.

A hyperlink is a reference to data that a user can interact with in order to access the referenced data. A hyperlink can point to a whole document or to a specific element within a document. Hyperlinks are commonly embedded as text within a document (i.e., hypertext). A document containing a hyperlink is commonly referred to as the source document. For example, an online document includes text of terms with corresponding embedded hyperlinks that direct to a definition of the term. Hyperlinks are often used to implement reference mechanisms such as tables of contents, footnotes, bibliographies, indexes, letters and glossaries.

### SUMMARY

Aspects of the present invention disclose a method, computer program product, and system for determining a presentation of URLs within a hyperlink. The method includes one or more processors determining information associated with a user accessing a document, wherein the document includes a hyperlink that is associated with a plurality of uniform resource locators (URLs). The method further includes one or more processors identifying, that the user selects the hyperlink within the document. The method further includes one or more processors determining a presentation of one of more URLs of the plurality of URLs of the hyperlink for the user based on the determined information associated with the user.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for analyzing a document that includes a hyperlink that references multiple web resources, in accordance with embodiments of the present invention.

FIG. 3 is a flowchart depicting operational steps of a program for determining a presentation of URLs within a hyperlink based on information associated with an accessing user, in accordance with embodiments of the present invention.

FIG. 4 depicts a block diagram of components of a computing system representative of the client devices and server of FIG. 1, in accordance with an embodiment of the present invention.

### DETAILED DESCRIPTION

Embodiments of the present invention allow for management and implementation of hyperlinks that can direct a user to one or more of a plurality of web resources, such as uniform resource locators (URLs). In addition, embodiments of the present invention can determine information associated with a user that is accessing a document. In response to determining that a user selects a hyperlink that links to a plurality of web resources, embodiments of the present invention can determine a presentation of the multiple web resources that is customized to the information associated with the user relative to the content of the web resources. For example, embodiments of the present invention can allow the user to provide input selecting one or more of the web resources referenced in the hyperlink, direct to user to one or more of the web resources referenced in the hyperlink (based on user preferences, user feedback, user context, user profile, job role, etc.).

Some embodiments of the present invention recognize that linking documents using hyperlinks embedded within the documents is a widely utilized feature in document management software and systems. Additional embodiments of the present invention recognize that currently, target hyperlinks use a one-to-one mapping with the source text (i.e., a hyperlink is hard coded to access a particular web resource in response to selection of the hyperlink).

Hyperlinks in a document can operate to direct a user to another document (i.e., target document) or another location within the document (i.e., the source document). Various embodiments of the present invention recognize that hyperlinks are used to perform actions including: opening a linked document to obtain detailed information on source text, provide a citation for information in a source document, link to an external (target) page/document/application, etc.

Embodiments of the present invention recognize that the static binding of the source text with a target hyperlink can provide limitations. Accordingly, embodiments of the present invention can provide the capability to associate multiple web resources within a single hyperlink, facilitating access to web resources that are increasingly relevant to the end user. For example, embodiments of the present invention can provide pre-fetched, collated, and summarized information from multiple URLs that are associated with a hyperlink.

Implementation of embodiments of the invention may take a variety of forms, and exemplary implementation details are discussed subsequently with reference to the Figures.

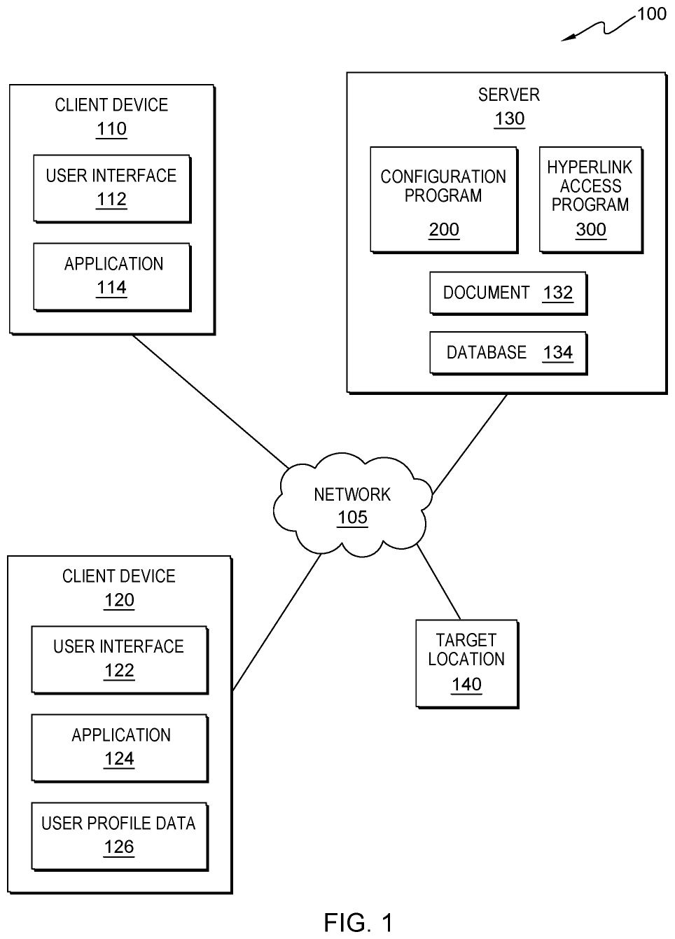

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes client device 110, client device 120, server 130, and target location 140, all interconnected over network 105. In an example embodiment, client device 110 and client device 120 are representative of computing devices are utilized by respective users within data processing environment 100. For example, client device 110 is a computing device associated with a content creator (e.g., a creator of a document, such as document 132) and client device 120 is a computing device associated with a user accessing a document (e.g., document 132). In this example embodiment, server 130 hosts the document (e.g., document 132) and can manage access and utilization of hyperlinks within the document, based on provided and derived user information, in accordance with embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between client device 110, client device 120, server 130, and target location 140, in accordance with embodiments of the present invention. In various embodiments, network 105 facilitates communication among a plurality of networked computing devices (e.g., client device 110, client device 120, and server 130), corresponding users (e.g., respective individuals utilizing client device 110 and client device 120), data sources (e.g., target location 140), and corresponding management services (e.g., server 130).

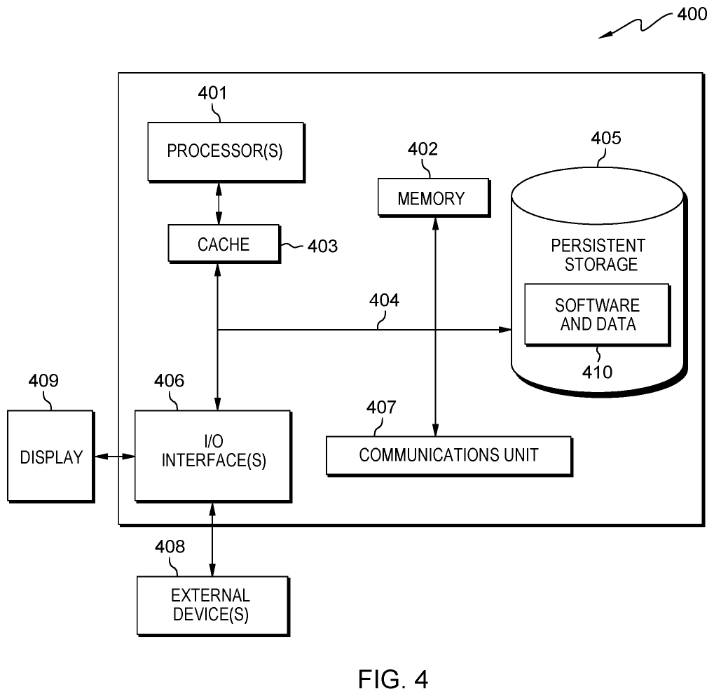

In various embodiments of the present invention, client device 110 and client device 120 may be a workstation, personal computer, personal digital assistant, mobile phone, or any other device capable of executing computer readable program instructions, in accordance with embodiments of the present invention. In general, client device 110 and client device 120 are representative of any electronic device or combination of electronic devices capable of executing computer readable program instructions. Client device 110 and client device 120 may include components as depicted and described in further detail with respect to FIG. 4, in accordance with embodiments of the present invention.

Client device 110 includes user interface 112 and application 114. User interface 112 is a program that provides an interface between a user of client device 110 and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on client device 110. In an example embodiment, application 114 is a client-side application of a service or enterprise associated with server 150. In another example embodiment, application 114 is a web browser that an individual utilizing client device 110 utilizes (e.g., via user interface 112) to access and provide information over network 105. For example, a user of computing device 110 provides input to user interface 112 to interact with a web browser (i.e., application 114) and access a document (e.g., document 132 hosted on server 130). In other aspects of the present invention, application 114 can be representative of applications that provide additional functionality (e.g., camera, messaging, etc.), in accordance with various aspects of the present invention.

In addition, client device 120 includes respective instances of user interface 122 and application 124. User interface 122 and application 124 include functionality as described above, with regard to respective instances of user interface 112 and application 114. In various embodiments of the present invention, client device 110 and client device 120 can access and interact with information, such as documents and web resources accessible over network 105.

Client device 120 includes user profile data 126. In various embodiments, user profile data 126 includes information provided by a user of client device 120 (e.g., a consumer user), such as during a registration process. For example, a user of client device 120 registers with a service provided by server 130, such as to access documents hosted on server 130. During the registration process, the user of client device 120 provides information associated with the user and user preference information, which client device 120 stores in user profile data 126. In a further embodiment, client device 120 can provide user profile data 126 to server 130 (e.g., for storage in database 134).

In example embodiments, user profile data 125 can include a job role of the user, user preference information, user activity information, user skill and characteristic information, contextual user information, or other forms of information provided by the user, in accordance with embodiments of the present invention. In another embodiment, user profile data 126 can include information that corresponds to client device 120, such as device characteristic information and device usage and context information, provided by the user of client device 120, in accordance with embodiments of the present invention.

In various embodiments of the present invention, respective users of client device 110 and client device 120 can register with server 130 (e.g., via a corresponding application). For example, the user completes a registration process, provides information, and authorizes the collection and analysis (i.e., opts-in) of relevant data on at least respective instances of client device 110 and client device 120, by server 130 (e.g., via communication with a client-side application, configuration program 200, hyperlink access program 300, access of user profile data 126, etc.). In various embodiments, a user can opt-in or opt-out of certain categories of data collection. For example, the user can opt-in to provide all requested information, a subset of requested information, or no information. In one example scenario, the user opts-in to provide user profile information and contextual information associated with device usage and document access, but opts-out of providing location-based information (on all or a subset utilized computing devices, such as client device 110 or client device 120).

In example embodiments, server 130 can be a desktop computer, a computer server, or any other computer systems, known in the art. In certain embodiments, server 130 represents computer systems utilizing clustered computers and components (e.g., database server computers, application server computers, etc.) that act as a single pool of seamless resources when accessed by elements of data processing environment 100 (e.g., client device 110 and client device 120). In general, server 130 is representative of any electronic device or combination of electronic devices capable of executing computer readable program instructions. Server 130 may include components as depicted and described in further detail with respect to FIG. 4, in accordance with embodiments of the present invention.

Server 130 includes document 132, database 134, configuration program 200, and hyperlink access program 300. In an example embodiment, server 130 hosts information that is accessible via network 105, such as web pages, applications, documents, etc. For example, server 130 can be representative of a document hosting web platform (e.g., hosting websites, blog posts, document repository, etc.).

In various embodiments, document 132 can be representative of any form of document accessible via network 105, in accordance with embodiments of the present invention. In example embodiments, document 132 is a rich document, hosted on server 130, that includes hyperlinks. For example, document 132 is a web page stored and written in HyperText Markup Language (HTML), stored on server 130 and accessible via network 105. In an example scenario, a user of client device 110 creates document 132 and sends document 132 to server 130. In this example scenario, a user of client device 110 accesses document 132 on server 130 (e.g., via application 124 over network 105), interacting with at least one hyperlink in document 132.

In example embodiments, document 132 includes at least one hyperlink that links to a plurality of web resources (e.g., in target location 140, accessible via network 105). Hyperlinks in a document can operate to direct a user to another document (i.e., target document) or another location within the document (i.e., the source document). Embodiments of the present invention recognize that the static binding of the source text with a target hyperlink can provide limitations. Accordingly, embodiments of the present invention can provide the capability to associate multiple web resources within a single hyperlink, facilitating access to web resources that are increasingly relevant to the end user.

For example, document 132 includes a hyperlink that includes a linked association with a multiple destination URLs (i.e., a multi-URL hyperlink), as defined by a creator of document 132 (i.e., the user of client device 110). In an example scenario, the creator of document 132 defines that a hyperlink in document 132 includes embedded links to URL A, URL B, and URL C. In this example scenario, the user of client device 120, while accessing document 132 on server 130, selects the hyperlink. In response to the selection of the hyperlink, server 130 utilizes hyperlink access program to determine a presentation for one or more of URL A, URL B, and URL C to the user of client device 120, in accordance with embodiments of the present invention.

In additional embodiments, server 130 utilizes database 134 to store information associated with registered users (e.g., users of client device 110 and client device 120), hosted content (e.g., document 132), and associated data sources (e.g., target location 140), in accordance with various embodiments of the present invention. Database 134 can be implemented with any type of storage device, for example, persistent storage 405, which is capable of storing data that may be accessed and utilized by server 130, client device 110, and client device 120, such as a database server, a hard disk drive, or a flash memory. In other embodiments, database 134 can represent multiple storage devices and collections of data within server 130.

In one embodiment, database 134 includes user preference information associated with registered users. For example, the user of client device 110 creates document 132 and sends (i.e., posts) document 132 to server 130. The user of client device 110 can provide preference information (e.g., a preferred default ranking of URLs within a hyperlink, data usage preferences, etc.), which server 130 stores in database 134 in association with document 132. In another example, the user of client device 120 has registered with a web platform associated with server 130 and accesses document 132 on server 130. Server 130 can determine information associated with the user of client device 120 (e.g., based on the authorized information provided by the user during registration) for storage in database 134. In this example, server 130 can identify information from user profile data 126 to store in database 134, such as user preferences, user job role, a user profile, current contextual information of device usage, etc.

In a further embodiment, database 134 includes data derived through a cognitive analysis of webpages and documents, such as target location 140 and document 132. In an example embodiment, server 130 can access (e.g., crawl) web resources that are referenced within hyperlinks of document 132 (e.g., web pages and documents corresponding to URLs in a hyperlink). Server 130 can derive information associated with the linked web resources (e.g., utilizing a cognitive engine for analysis, not shown) and store the derived information in database 134 to utilize in accordance with various embodiments of the present invention. For example, server 130 can crawl target web pages (e.g., target location 140) and determine metadata tag information, a mapping of URLs, contextual information associated with URLs, ranking information associated with URLs, URL priority information, etc., which server 130 can store in database 134.

In example embodiments, configuration program 200 analyzes a document that includes a hyperlink that references multiple web resources, in accordance with embodiments of the present invention. In various embodiments, configuration program 200 receives input of a document and identifies a hyperlink that corresponds to multiple web resources (i.e., a multi-URL hyperlink). Further, configuration program 200 determined and stores a raking of the target web resources in the hyperlink.

In another example embodiment, hyperlink access program 300 determines a presentation of URLs within a hyperlink based on information associated with an accessing user, in accordance with embodiments of the present invention. In various embodiments, hyperlink access program 300 determines information associated with a user that is accessing a document. Further, in response to the user selecting a hyperlink (i.e., a multi-URL hyperlink) in the document, hyperlink access program 300 determines a customized presentation of one or more URLs within the selected hyperlink based on the determined information associated with the user. Accordingly, hyperlink access program 300 presented at least one of the URLs to the user, based on the determined customized presentation.

In further embodiments, target location 140 is representative of a target web resource that is linked in a hyperlink, such as a destination of a URL. In additional embodiments, data processing environment 100 can include additional target locations (not shown), in accordance with various embodiments of the present invention. In another embodiment, target location 140 can be located on server 130 (e.g., also hosted by the document hosting platform of server 130). For example, in response to a user of client device 120 selecting a multi-URL hyperlink in document 132, server 130 (via hyperlink access program 300) can direct the user to one or more web resources that are located in target location 140.

In an example scenario, target location 140 is reference resource (e.g., database of documents, web page, etc.) that includes information associated with computing environments and systems. In this example scenario, document 132 includes a multi-URL hyperlink for the topic of “Virtual Machines,” which includes URLs that reference a plurality of web resources located in target location 140. For example, multi-URL hyperlink includes URLs that target multiple sections within target location 140, such as “Virtual Machine Overview,” “Virtual Machines for Beginners,” “Virtual Machines for Experts,” “Deploying Virtual Machines,” “Enterprise Virtual Machine Offerings,” etc.

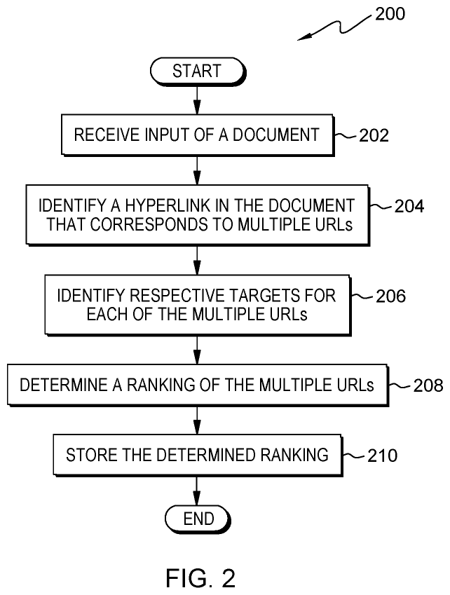

FIG. 2 is a flowchart depicting operational steps of configuration program 200, a program for analyzing a document that includes a hyperlink that references multiple web resources, in accordance with embodiments of the present invention. In one embodiment, configuration program 200 operates to monitor incoming documents for hosting and/or publishing on server 130. For example, configuration program 200 identifies webpages, blogs, documents, etc., which are submitted for publishing on a hosting and distribution platform of server 130.

In step 202, configuration program 200 receives input of a document. In one embodiment, configuration program 200 receives document 132, intended for publishing on a document hosting platform of server 130. In an example embodiment, a user of client device 120 (i.e., content creator) sends document 132 to server 130 for publishing.

In step 204, configuration program 200 identifies a hyperlink in the document that corresponds to multiple URLs. In one embodiment, configuration program 200 parses document 132 (input in step 202), analyzing hyperlinks within document 132 to identify at least one hyperlink that includes that links to a plurality of web resources (i.e., a multi-URL hyperlink). In another embodiment, configuration program 200 parses document 132 to identify a tag that indicates a hyperlink, or URL of the hyperlink, is a Representational state transfer (REST) application programming interface (API). For example, configuration program 200 can identify hyperlinks within document 132 and determined whether the identified hyperlinks reference one, or more than one, web resource via URL.

In an example embodiment, a content creator (i.e., user of client device 110) creates a hyperlink within a document and associates the hyperlink with more than one URL (i.e., web resource). The multiple URLs are included within the hyperlink of the HTML document (i.e., document 132) when the content creator posts the document to server 130 (in step 202). Accordingly, subsequent to receiving the document, server 130, utilizing configuration program 200, processes the document and identifies multi-URL hyperlinks within the document.

In an example scenario, document 132 includes information associated with computing environments and systems. During creation or revision of document 132, the user of client device 110 creates a multi-URL hyperlink within for the topic of “Virtual Machines,” which includes URLs that reference a plurality of web resources located in target location 140. In this example scenario, the multi-URL hyperlink includes URL A that directs (with respect to target location 140) to the “Virtual Machine Overview” section, URL B that directs to the “Virtual Machines for Beginners” section, URL C that directs to the “Virtual Machines for Experts” section, URL D that directs to the “Deploying Virtual Machines” section, and URL E that directs to the “Enterprise Virtual Machine Offerings” section. Accordingly, subsequent to receiving document 132 uploaded to server 130, configuration program 200 identifies the multi-URL hyperlink while parsing document 132.

In step 206, configuration program 200 identifies respective targets for each of the multiple URLs. In one embodiment, configuration program 200 analyzes the multi-URL hyperlink (identified step 204) and identifies the respective target web resources that are linked to in the multiple URLs. In various embodiments, the URLs can direct to one or more target locations, such as target location 140 and additional target locations (not shown). In another embodiment, the URLs can direct to multiple web resources within a since target location, such as target location 140. In example embodiments, configuration program 200 access the URLs within the hyperlink (e.g., web crawling). For example, configuration program 200 crawls each link and determines a context associated with the respective link (e.g., development, infrastructure, project management, finance, expert, etc.) and save the derived contextual information in database 134.

In the previously discussed example scenario, document 132 includes a multi-URL hyperlink within for the topic of “Virtual Machines,” which includes URLs that reference a plurality of web resources located in target location 140. In this example scenario, configuration program 200 identifies the target web resources in the multi-URL hyperlink. For example, configuration program 200 identifies that the URLs direct to different sections of target location 140, the respective target web resources including URL A that directs (with respect to target location 140) to the “Virtual Machine Overview” section, URL B that directs to the “Virtual Machines for Beginners” section, URL C that directs to the “Virtual Machines for Experts” section, URL D that directs to the “Deploying Virtual Machines” section, and URL E that directs to the “Enterprise Virtual Machine Offerings” section.

In step 208, configuration program 200 determines a ranking of the multiple URLs. In one embodiment, configuration program 200 determines a ranking of the one or more target web resources of the URLs within the multi-URL hyperlink. In an example embodiment, configuration program 200 analyses the target web resources (e.g., sections of target location 140) to determine a default ranking for the target web resources (e.g., a predicted order of consumption). In another embodiment, configuration program 200 can operate intermittently (e.g., at defined time intervals) to determine updates to the ranking of target web resource sin a multi-URL hyperlink.

In various embodiments, configuration program 200 accesses and analyzes web content to derive information relevant to ranking target web resources (and storing data in database 134). In an example, configuration program 200 crawls target web content to identify corresponding interaction information, such likes/dislikes, comments, page hits, etc. In another example, configuration program 200 can utilize cognitive processing capabilities (of server 130 and/or an external system, not shown) to analyze the content of target web content. In an additional embodiment, configuration program 200 can analyze information associated with users accessing the target web content, based on user profile data of users that are registered with server 130. Accordingly, configuration program 200 determines the ranking of the multiple URLs based on derived information from web crawling, database 134, etc.

For example, configuration program 200 determines a default ranking that corresponds to interaction information of the target URLs, such as assigning the URL of the web resource with the most interactions (e.g., comments, likes, hits, etc.) the highest ranking, etc. With regard to the previously discussed example scenario of document 132 includes a multi-URL hyperlink within for the topic of “Virtual Machines,” configuration program 200 determined a ranking of the URLs within the multi-URL hyperlink based on respective quantities of page hits for the respective sections of target location 140.

In step 210, configuration program 200 stores the determined ranking. In one embodiment, configuration program 200 stores the ranking (determined in step 208) as the default (or baseline) ranking of the URLs in the multi-URL hyperlink, in database 134, associated with document 132. In additional embodiments, configuration program 200 can repeat step 208 at defined time intervals to determine an updated baseline ranking of URLs. In further aspects, hyperlink access program 300 utilizes the determined ranking as a baseline ranking for the URLs of the multi-URL hyperlink, in accordance with various embodiments of the present invention.

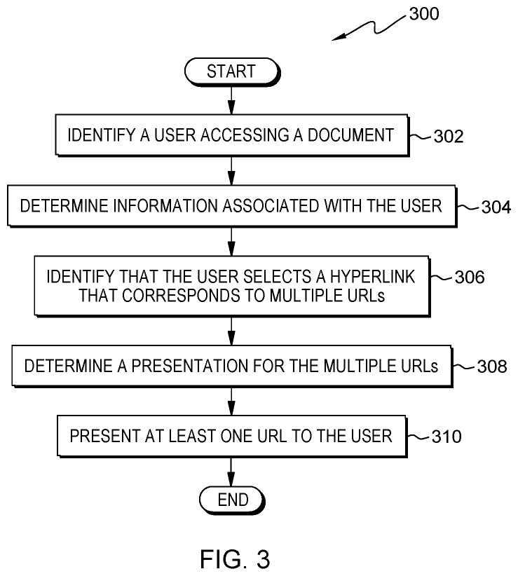

FIG. 3 is a flowchart depicting operational steps of hyperlink access program 300, a program for determining a presentation of URLs within a hyperlink based on information associated with an accessing user, in accordance with embodiments of the present invention. In one embodiment, hyperlink access program 300 operates on server 130 to monitor documents that server 130 hosts, such as document 132. In another embodiment, hyperlink access program 300 initiates in response to a establishing a connection with server 130 (e.g., via accessing a hosted document).

In step 302, hyperlink access program 300 identifies a user accessing a document. In one embodiment, hyperlink access program 300 identifies that a consumer user, utilizing client device 120, accesses document 132 (e.g., the user selects to view document 132). In another embodiment, hyperlink access program 300 determines identification information for a user accessing document 132. For example, the user utilizing client device 120 has registered with server 130 (providing user profile data 136). In this example, hyperlink access program 300 identifies information associated with the user of client device 120, stored in database 134, such as a registered user profile that indicates an identity of the user.

In step 304, hyperlink access program 300 determines information associated with the user. In one embodiment, hyperlink access program 300 determines information associated with the user identified to be accessing document 132 (in step 302). Hyperlink access program 300 can access database 134 to identify information associated with the user, such as information provided by the user in a registration process (e.g., a user profile, etc.). In addition, hyperlink access program 300 can determine contextual information associated with the user (e.g., current and/or recent activity of the user on client device 120).

In an example embodiment, hyperlink access program 300 analyzes a user profile associated with the user accessing document 132 and determines skill level information (relative to a topic of document 132, such as Virtual Machines) and job role information associated with the user (e.g., product developer, finance, executive, etc.). In another example embodiment, hyperlink access program 300 determined current contextual information associated with the user viewing document 132. For example, hyperlink access program 300, when authorized by the user, determine activity of the user utilizing client device 120, such as recent activity while accessing information on server 130. In additional embodiments, hyperlink access program 300 utilizes user preference information of the user (e.g., stored in database 134) to derive relevant information (e.g., type of content preference, etc.).

In step 306, hyperlink access program 300 identifies that the user selects a hyperlink that corresponds to multiple URLs. In one embodiment, hyperlink access program 300 identifies that the user accessing document 132 (identified in step 302) provides input (e.g., via user interface 122 of client device 120) selecting a multi-URL hyperlink in document 132. In other embodiments, hyperlink access program 300 can identify a selection of a multi-URL hyperlink in document 132 concurrently with, or prior to, step 304. Hyperlink access program 300 can monitor activity of users viewing document 132 to determine when a user selects a multi-URL hyperlink.

In step 308, hyperlink access program 300 determines a presentation for the multiple URLs. In one embodiment, hyperlink access program 300 determines a presentation of one or more web resources of URLs of the multi-URL hyperlink of document 132 (selected in step 306), utilizing the determined information associated with the user (from step 304). In various embodiments, hyperlink access program 300 utilizes information associated with the content consumer user (i.e., user of client device 120) and the content creator user (i.e., the user of client device 110) for document 132 when determining a presentation of web resources of the URLs, in accordance with various aspects of the invention. In example embodiments, hyperlink access program 300 determines a presentation for the web resources of the URLs in the multi-URL hyperlink that includes whether to present one or more of the web resources and/or which one or more web resources to present to the user.

In the previously discussed example scenario, document 132 includes a multi-URL hyperlink within for the topic of “Virtual Machines,” which includes URLs that reference a plurality of web resources located in target location 140. In this example scenario, hyperlink access program 300 identifies that the user selects the multi-URL hyperlink within for the topic of “Virtual Machines.” Accordingly, in various aspects of the present invention, hyperlink access program 300 determines a presentation of the one or more web resources of URLs of the multi-URL hyperlink of document 132 (i.e., of URL A, URL B, URL C, URL D, and URL E).

In an example aspect, hyperlink access program 300 determines a presentation of opening each of the web resources of the URLs of the multi-URL hyperlink. In this example aspect, hyperlink access program 300 opens each of URL A, URL B, URL C, URL D, and URL E. In various embodiments, hyperlink access program 300 determines an order to open the URLs based on a default or baseline ranking of the web resources or determines an updated ranking utilizing information associated with the user (discussed previously with regard to step 208 of configuration program 200). In a further embodiment, hyperlink access program 300 determines a presentation of a selectable user interface element that includes the multiple URLs of the multi-URL hyperlink, which allows the user to select to present one or more of the URLs.

In another example aspect, hyperlink access program 300 determines a presentation of the multiple URLs based on information associated with the user (e.g., information in database 134, user preferences, user feedback, etc.). Hyperlink access program 300 can determine a presentation based on which particular user selects the hyperlink. In this example aspect, hyperlink access program 300 can determine a presentation for the multiple URLs based on job role and/or topic skill level associated with the user (e.g., derived from a user profile). For example, hyperlink access program 300 compares job role and skill information in a user profile of a user to a respective topic or context of the web resources of the URLs. In this example, hyperlink access program 300 determines a presentation that includes opening the URLs of topics that are associated with the job role or skill level of the user (e.g., URL C, directing to the “Virtual Machines for Experts” section in target location 140 for a software developer user, etc.).

In a further example aspect, hyperlink access program 300 determines a presentation of the multiple URLs based on contextual information associated with the user viewing document 132, such as recent activity while accessing information on server 130. Hyperlink access program 300 can utilize detected activity data of the user to determine a presentation for the multiple URLs. For example, hyperlink access program 300 determines that the user was previously accessing tutorial documents. In this example, hyperlink access program 300 determines a presentation that includes opening the URLs associated with learning, or users with low skill levels (e.g., URL B that directs to the “Virtual Machines for Beginners” section in target location 140). In another aspect, for users that are not registered with server 130 (or not logged in), hyperlink access program 300 can utilize a baseline ranking, or creator preference, to determine a presentation of one or more of the multiple URLs (e.g., based on information from the content creator of document 132 and ranking information determined by configuration program 200).

In an additional example aspect, hyperlink access program 300 determines that the hyperlink, or URL of the hyperlink, is a Representational state transfer (REST) application programming interface (API) and determines a presentation utilizing the REST API. For example, hyperlink access program 300 determines a presentation that includes executing an API call and presenting the output of the API call. In an example embodiment, hyperlink access program 300 can present the output of an API call as a user interface element associated with the hyperlink (e.g., a tooltip, rendered inline, etc.). In a further embodiment, hyperlink access program 300 can retrieve summarized text associated with URLs. Accordingly, hyperlink access program 300 can determine a presentation that includes rendering summary information for one or more URLs (e.g., a new window, a dialog box, tooltip, user interface element, etc.).

In various embodiments, hyperlink access program 300 can utilize one or more of aforementioned example aspects in the process of determining a presentation of one or more of the multiple URLs of the multi-URL hyperlink, in accordance with embodiments of the present invention.

In step 310, hyperlink access program 300 presents at least one URL to the user. In one embodiment, hyperlink access program 300 executes the determined presentation of the URLs of the selected multi-URL hyperlink of document 132 (determined in step 308). In various embodiments, hyperlink access program 300 presents respective web resources of at least one URL of the multi-URL hyperlink to the user, based on information associated with the user (e.g., user profile, user context, etc.), according to the presentation determined in step 308. Accordingly, hyperlink access program 300 can present one web resource, a set of the web resources, or all web resources, in accordance with various embodiments of the present invention. In further embodiments, hyperlink access program 300 can gather user feedback on web resource and URL presentation, which hyperlink access program 300 can utilize to update user preference and feedback data in database 134.

Various embodiments of the present invention utilize configuration program 200 and hyperlink access program 300 to facilitate a streamlined experience of including multiple URLs within a hyperlink and creating a customized presentation of web resources for the accessing user.

FIG. 4 depicts computer system 400, which is representative of client device 110, client device 120, and server 130, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to client device 110, software and data 410 includes user interface 112 and application 114. With respect to client device 120, software and data 410 includes user interface 122, application 124, and user profile data 126. With respect to server 130, software and data includes configuration program 200, hyperlink access program 300, document 132, and database 134.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
determining, by one or more processors, information associated with a user accessing a document, wherein the document includes a hyperlink that is associated with a plurality of uniform resource locators (URLs);
identifying, by one or more processors, that the user selects the hyperlink within the document; and
determining, by one or more processors, a presentation of one of more URLs of the plurality of URLs of the hyperlink for the user based on the determined information associated with the user.

2. The method of claim 1, wherein determining the presentation of one of more URLs of the plurality of URLs of the hyperlink for the user, further comprises:
presenting, by one or more processors, all of the plurality of URLs to the user.

3. The method of claim 1, wherein determining the presentation of one of more URLs of the plurality of URLs of the hyperlink for the user, further comprises:
identifying, by one or more processors, a URL of the plurality of URLs that is associated with user profile information of the user; and
presenting, by one or more processors, the identified URL to the user.

4. The method of claim 1, wherein determining the presentation of one of more URLs of the plurality of URLs of the hyperlink for the user, further comprises:
determining, by one or more processors, contextual information associated with the user, wherein the contextual information includes recent activity of the user;
identifying, by one or more processors, a URL of the plurality of URLs that is associated with the determined contextual information; and
presenting, by one or more processors, the identified URL to the user.

5. The method of claim 1, wherein determining the presentation of one of more URLs of the plurality of URLs of the hyperlink for the user, further comprises:
presenting, by one or more processors, information associated with the one or more URLs as a user interface element, wherein the information associated with the one or more URLs is selected from the group consisting of: a content summary, selectable links, and information retrieved through an application programming interface (API) call.

6. The method of claim 1, wherein the document is selected from the group consisting of:
a webpage, a blog post, a message, and a network-accessible web document.

7. The method of claim 1, wherein the determined information associated with the user includes a user job role and user preferences.

8. A computer program product comprising:
one or more computer readable storage media and program instructions stored on the one or more computer readable storage media, the program instructions comprising:
program instructions to determine information associated with a user accessing a document, wherein the document includes a hyperlink that is associated with a plurality of uniform resource locators (URLs);
program instructions to identify that the user selects the hyperlink within the document; and
program instructions to determine a presentation of one of more URLs of the plurality of URLs of the hyperlink for the user based on the determined information associated with the user.

9. The computer program product of claim 8, wherein the program instructions to determine a presentation of one of more URLs of the plurality of URLs of the hyperlink for the user, further comprise program instructions to:
present all of the plurality of URLs to the user.

10. The computer program product of claim 8, wherein the program instructions to determine a presentation of one of more URLs of the plurality of URLs of the hyperlink for the user, further comprise program instructions to:
identify a URL of the plurality of URLs that is associated with user profile information of the user; and
present the identified URL to the user.

11. The computer program product of claim 8, wherein the program instructions to determine a presentation of one of more URLs of the plurality of URLs of the hyperlink for the user, further comprise program instructions to:
determine contextual information associated with the user, wherein the contextual information includes recent activity of the user;
identify a URL of the plurality of URLs that is associated with the determined contextual information; and
present the identified URL to the user.

12. The computer program product of claim 8, wherein the program instructions to determine a presentation of one of more URLs of the plurality of URLs of the hyperlink for the user, further comprise program instructions to:
present information associated with the one or more URLs as a user interface element, wherein the information associated with the one or more URLs is selected from the group consisting of: a content summary, selectable links, and information retrieved through an application programming interface (API) call.

13. The computer program product of claim 8, wherein the document is selected from the group consisting of: a webpage, a blog post, a message, and a network-accessible web document.

14. A computer system comprising:
one or more computer processors;
one or more computer readable storage media; and
program instructions stored on the computer readable storage media for execution by at least one of the one or more processors, the program instructions comprising:
program instructions to determine information associated with a user accessing a document, wherein the document includes a hyperlink that is associated with a plurality of uniform resource locators (URLs);
program instructions to identify that the user selects the hyperlink within the document; and
program instructions to determine a presentation of one of more URLs of the plurality of URLs of the hyperlink for the user based on the determined information associated with the user.

15. The computer system of claim 14, wherein the program instructions to determine a presentation of one of more URLs of the plurality of URLs of the hyperlink for the user, further comprise program instructions to ng:
present all of the plurality of URLs to the user.

16. The computer system of claim 14, wherein the program instructions to determine a presentation of one of more URLs of the plurality of URLs of the hyperlink for the user, further comprise program instructions to:
identify a URL of the plurality of URLs that is associated with user profile information of the user; and
present the identified URL to the user.

17. The computer system of claim 14, wherein the program instructions to determine a presentation of one of more URLs of the plurality of URLs of the hyperlink for the user, further comprise program instructions to:
determine contextual information associated with the user, wherein the contextual information includes recent activity of the user;
identify a URL of the plurality of URLs that is associated with the determined contextual information; and
present the identified URL to the user.

18. The computer system of claim 14, wherein the program instructions to determine a presentation of one of more URLs of the plurality of URLs of the hyperlink for the user, further comprise program instructions to:
present information associated with the one or more URLs as a user interface element, wherein the information associated with the one or more URLs is selected from the group consisting of: a content summary, selectable links, and information retrieved through an application programming interface (API) call.

19. The computer system of claim 14, wherein the document is selected from the group consisting of: a webpage, a blog post, a message, and a network-accessible web document.

20. The computer system of claim 14, wherein the determined information associated with the user includes a user job role and user preferences.
